(19) United States
(12) Patent Application Publication
(10) Pub. No.: US 2006/0243709 A1
(43) Pub. Date: Nov. 2, 2006

(54) Method and device for restoring and producing geometrically complex components

(76) Inventors: Werner Born, Friedberg (DE); Reinhold Meier, Dorfen (DE); Ludwig Schaller, Reichertshofen (DE)

Correspondence Address: KENYON & KENYON LLP, ONE BROADWAY, NEW YORK, NY, 10004, US

(21) Appl. No.: 10/547,402

(22) PCT Filed: Dec. 23, 2003
(86) PCT No.: PCT/DE03/04280

§ 371 Date: Jun. 20, 2006

(30) Foreign Application Priority Data
Feb. 28, 2003 (DE) 10308979.9

(51) Int. Cl. B23K 26/28

(52) U.S. Cl. 219/121.64

(57) ABSTRACT

A method is provided for restoring geometrically complex components having damage or defects in regions of limited access, in which damaged or defective pieces are cut out of the components and replacement pieces of the same kind are welded in, the cutting and the welding being performed with the aid of laser energy. Using a CNC-controlled laser beam, a damaged or defective piece is cut out of a component. Using a laser beam and the same path data, modified by a correction if necessary, a replacement piece is cut out of a repair part. Using a laser beam and the same path data as in A, the replacement piece is welded into the component. A space-saving special adapter is used in the three foregoing machining steps. During the first three machining steps, the component remains in the same clamped support.

### FIELD OF THE INVENTION

The present invention relates to a method for restoring and producing geometrically complex components, as well as to a device for implementing these methods.

### BACKGROUND INFORMATION

Especially in the flow channel region of gas turbines, components are subject to wear by oxidation, corrosion and erosion. Extensive deformations, cracks and holes may occur, repair or replacement becoming necessary after a certain degree of damage. Component parts such as blades are relatively easy to replace or restore in an uninstalled state. However, there are also complex, integral components such as housing sections having pipe-like, concentric wall elements and having multiple braces connecting the latter, with respect to which a repair is normally preferred over a complete replacement for reasons of costs or with respect to which the production of new parts is already difficult. There are also cases where such components already have unacceptable defects in new condition. In such cases, a repair of the expensive parts is desired as well. Damage and defects may also occur in regions that are difficult to access for tools such as cutting and welding equipment. It is conventional to use laser energy for cutting out defective pieces and for welding in replacement pieces. Standard focusing heads of industrially used laser equipment are too large on account of auto focus and rotational axes and are thus not suited for use in narrowly confined spaces.

### SUMMARY

An example embodiment of the present invention may provide a method including a device for restoring and producing geometrically complex components having regions of limited access using laser technology, as a result of which repairs and production may become more cost-effective, may be more precisely reproducible and achievable with less welding shrinkage or in many cases may become possible for the first time.

During the entire machining process, a space-saving special adapter in the form of a so-called tube or a holder having a light guide, by which the laser beam may be guided, deflected and focused on the cutting or welding zone. For this purpose, the special adapter has an adjustable focusing device. The special adapter and thus the laser beam is moved in a CNC-controlled manner, the path data remaining the same in cutting and in welding.

Example embodiments of the present invention are explained in greater detail below with reference to the appended Figures.

### BRIEF DESCRIPTION OF THE DRAWINGS

FIG. 1 schematically illustrates cutting a piece out of a component.

FIG. 2 schematically illustrates cutting a replacement piece out of a repair part as well as welding the replacement piece into the component.

### DETAILED DESCRIPTION

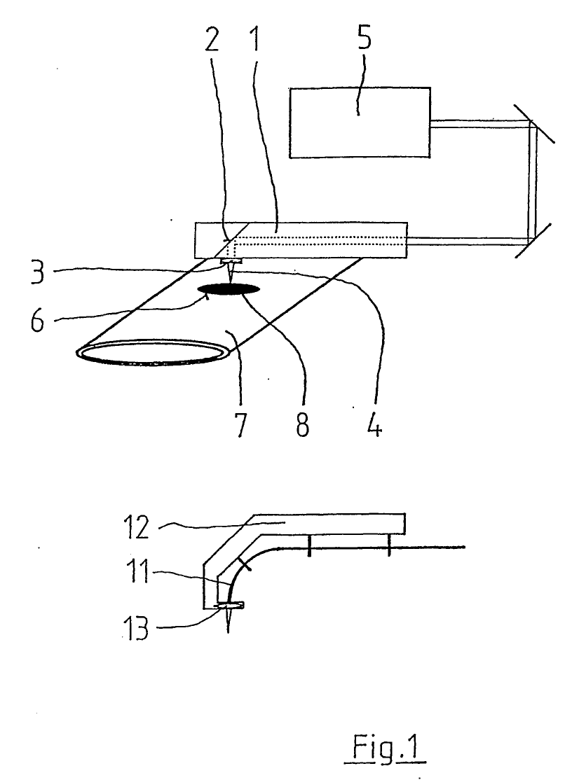

The component 7 illustrated in FIG. 1 is one of several braces of a gas turbine housing section. Such a housing section forms an integral component having two pipe-like concentric wall elements, which are connected via several radial braces distributed across the periphery. In operation, the aerodynamically profiled braces are exposed on their entire outer surface to hot, aggressive gases, which may cause damage by corrosion, erosion, crack-formation, deformation, burn-through, etc. The interstices between the braces are accessible to tools only to a limited degree due to spatial constraints. For the purpose of clarity, FIG. 1 illustrates only half of such a brace without the adjacent or connected elements. The machining tool itself is formed by a space-saving, pipe-like tube 1, which is optically connectible to a laser source 5. For example, laser source 5 may be a CO₂ laser, an Nd:YAG laser or another suitable laser type, etc. As illustrated, the unfocused or pre-focused laser beam in tube 1 is deflected by 90° using a deflecting mirror arrangement 2 and is focused on the surface of component 7 using an adjustable focusing device 3. The beam deflection in tube 1 may be different than 90°. Tube 1 is mechanically coupled to a CNC-controlled machine such as an industrial robot, a portal system, etc. and is moved by it. In the process, laser beam 4 is guided along a self-enclosed path 6 in order to cut a damaged or defective piece 8 out of component 7. At the bottom of FIG. 1, a holder 12 having a light guide 11 and a focusing device 13 is illustrated as an alternative to tube 1.

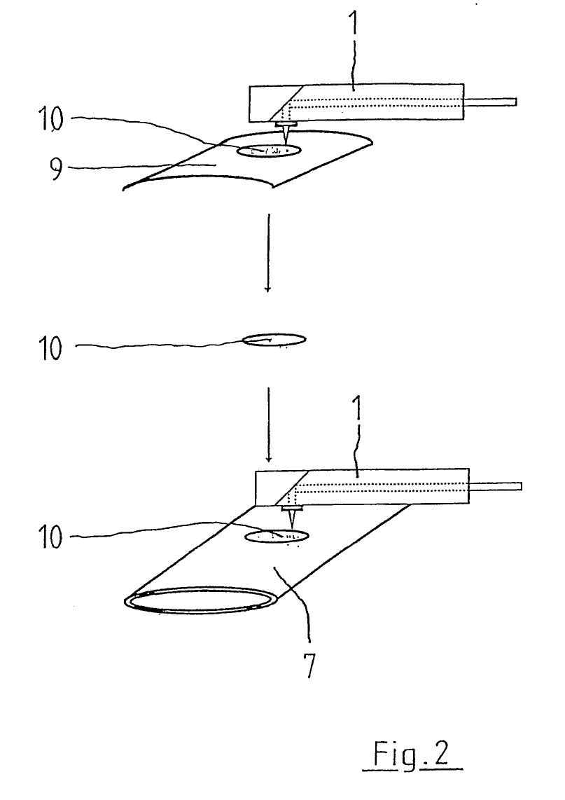

According to the top part of FIG. 2, a replacement piece 10 corresponding to piece 8, but free of defect, is cut out of a repair piece 9 that is at least largely identical to the affected component region using the same path data and the same tube 1. Compared to the path data according to FIG. 1, for producing replacement piece 10 it is possible to allow for a small lateral path correction (gap correction) that is constant over the length of the path.

According to the bottom part of FIG. 2, replacement piece 10 is welded using tube 1 into the hole in component 7 in place of the defective piece 8. Focusing device 3 may be set differently for welding than for cutting.

In all of the machining steps illustrated, the same tube 1 or the same holder 12 having light guide 11 is used, component 7 remains in one and the same clamped support, and the repair part may be located near component 7 such that it may be machined without great travel of tube 1.

1-6. (canceled)

7. A method for restoring a geometrically complex component having at least one of (a) damage and (b) a defect in a region of limited access, comprising:
(a) cutting at least one of (a) a damaged piece and (b) a defective piece from the component with a laser beam moved in a numerically-controlled manner on a self-enclosed path;
(b) cutting a replacement piece from a repair part with the laser beam and with a same path data as in the cutting step (a) modified by a gap correction, if necessary, a material and a geometry of the replacement piece comparable to identical to the at least one of (a) the damaged piece and (b) the defective piece; and
(c) welding the replacement piece into the component with the laser beam and the same path data as in the cutting step (a);
wherein the steps (a), (b) and (c) include guiding the laser beam one of (a) unfocused and (b) prefocused, refracting the laser beam and one of (a) focusing and (b) refocusing the laser beam with a space-saving special adapter in the form of one of (a) a tube and (b) a holder having a light guide, the component remaining in a same clamped support during the steps (a), (b) and (c).

8. The method according to claim 7, wherein the laser beam is focused in the steps (a), (b) and (c) differently for the cutting than for the welding.

9. The method according to claim 7, wherein the component includes a gas turbine housing section having two concentric wall elements and multiple braces connecting the wall elements, the at least one of (a) the damage and (b) the defect being present in a region of at least one of (a) the braces and (b) wall regions.

10. A method for producing a geometrically complex component having regions of limited access, comprising:
(a) cutting to fit accurately a first element produced in oversize with a laser beam moved in a numerically controlled manner on a self-enclosed path;
(b) cutting to fit accurately a second element adjacent to the first element and produced in oversize with the laser beam and with a same path data as in the cutting step (a) modified by a gap correction, if necessary;
(c) welding the first element and the second element with the laser beam and with the same path data as in the cutting step (a);
wherein the steps (a), (b) and (c) include guiding the laser beam one of (a) unfocused and (b) prefocused, refracting the laser beam and one of (a) focusing and (b) refocusing the laser beam with a space-saving special adapter in the form of one of (a) a tube and (b) a holder having a light guide.

11. The method according to claim 10, wherein the laser beam is focused in the steps (a), (b) and (c) differently for the cutting than for the welding.

12. The method according to claim 10, wherein the component includes a gas turbine housing section having two concentric wall elements and multiple braces connecting the wall elements.
